(19) United States
(12) Patent Application Publication
(10) Pub. No.: US 2026/0236505 A1
(43) Pub. Date: Aug. 13, 2026

(54) SAMPLE DATA GENERATION METHOD

(71) Applicant: Tencent Technology (Shenzhen) Company Limited, Shenzhen (CN)

(72) Inventors: Zhen YANG, Shenzhen (CN); Ruobing XIE, Shenzhen (CN); Zihao AN, Shenzhen (CN); Xingwu SUN, Shenzhen (CN); Fengzong LIAN, Shenzhen (CN); Zhanhui KANG, Shenzhen (CN)

(73) Assignee: Tencent Technology (Shenzhen) Company Limited, Shenzhen (CN)

(21) Appl. No.: 19/640,400

(22) Filed: Apr. 6, 2026

Related U.S. Application Data
(63) Continuation of application No. PCT/CN2024/127023, filed on Oct. 24, 2024.

(30) Foreign Application Priority Data
Dec. 26, 2023 (CN) 202311810096.3

(51) Int. Cl. G06F 16/3329; G06F 18/214; G06F 18/25

(52) U.S. Cl. CPC G06F 16/33295; G06F 18/2148; G06F 18/25

(57) ABSTRACT

In a data generation method, a question instruction of a first-round dialog is determined based on one or more initial question instructions from a first large language model. In the method, a multi-round dialog is conducted. The multi-round dialog includes the first-round dialog that includes generating an answer text of the first-round dialog through a second large language model based on the question instruction of the first-round dialog. The multi-round dialog includes one or more subsequent-round dialogs, each including generating a question instruction of a current-round through the third large language model based on an answer text of a previous-round and generating an answer text of the current-round through the second large language model based on the question instruction of the current-round. In the method, sample data is constructed based on the question instructions in the multi-round dialog and the answer texts in the multi-round dialog.

### RELATED APPLICATIONS

The present application is a continuation of International Application No. PCT/CN2024/127023, filed on Oct. 24, 2024, which claims priority to Chinese Patent Application No. 202311810096.3, entitled “SAMPLE DATA GENERATION METHOD AND APPARATUS, ELECTRONIC DEVICE, AND STORAGE MEDIUM,” and filed on Dec. 26, 2023. The entire disclosures of the prior applications are hereby incorporated by reference.

### FIELD OF THE TECHNOLOGY

This disclosure relates to the technical field of artificial intelligence, including a sample data generation method and apparatus, an electronic device, and a storage medium.

### BACKGROUND OF THE DISCLOSURE

In the field of artificial intelligence, a large language model (LLM) refers to a deep learning model trained by using a large amount of text data, and can generate a natural language text or understand meaning of a language text. The large language model can process a plurality of natural language tasks, such as text classification, question answering, and dialogs.

In some applications, sample data for training a large language model may be obtained in a plurality of manners. For example, high-quality sample data may be obtained in a manual construction manner, but diversified sample data may not be efficiently obtained in the manual construction manner. For another example, a large amount of sample data may be collected through an online platform, but quality of the sample data may be relatively low, and data cleaning thereof may take a relatively long time. High-quality and diversified sample data may not be efficiently obtained in a sample data acquiring manner, and there may be a need for a method that can efficiently obtain high-quality and diversified sample data.

### SUMMARY

Embodiments of this disclosure provide a sample data generation method and apparatus, an electronic device, and a storage medium.

According to an aspect, an embodiment of this disclosure provides a sample data generation method. In the method, one or more initial question instructions are generated by a question instruction prediction based on a first prompt text through a first large language model. In the method, a question instruction of a first-round dialog of a multi-round dialog is determined based on the one or more initial question instructions. In the method, the multi-round dialog is conducted through a second large language model and a third large language model. The multi-round dialog includes the first-round dialog that includes generating an answer text of the first-round dialog through the second large language model based on the question instruction of the first-round dialog. The multi-round dialog includes one or more subsequent-round dialogs, each round of the one or more subsequent-round dialogs including generating a question instruction of a current-round dialog through the third large language model based on an answer text of a previous-round dialog and generating an answer text of the current-round dialog through the second large language model based on the question instruction of the current-round dialog. In the method, sample data is constructed based on the question instructions in the multi-round dialog and the answer texts in the multi-round dialog, the sample data for training a target large language model.

According to an aspect, an embodiment of this disclosure provides a sample data generation apparatus that includes processing circuitry configured to generate one or more initial question instructions by a question instruction prediction based on a first prompt text through a first large language model. The processing circuitry is configured to determine a question instruction of a first-round dialog of a multi-round dialog based on the one or more initial question instructions. The processing circuitry is configured to conduct the multi-round dialog through a second large language model and a third large language model. The multi-round dialog includes the first-round dialog that includes generation of an answer text of the first-round dialog through the second large language model based on the question instruction of the first-round dialog. The multi-round dialog includes one or more subsequent-round dialogs, each round of the one or more subsequent-round dialogs including generation of a question instruction of a current-round dialog through the third large language model based on an answer text of a previous-round dialog and generation of an answer text of the current-round dialog through the second large language model based on the question instruction of the current-round dialog. The processing circuitry is configured to construct sample data based on the question instructions in the multi-round dialog and the answer texts in the multi-round dialog, the sample data for training a target large language model.

According to an aspect, an embodiment of this disclosure provides a non-transitory computer-readable storage medium storing instructions, which when executed by a processor, cause the processor to perform a data generation method. In the method, one or more initial question instructions are generated by a question instruction prediction based on a first prompt text through a first large language model. In the method, a question instruction of a first-round dialog of a multi-round dialog is determined based on the one or more initial question instructions. In the method, the multi-round dialog is conducted through a second large language model and a third large language model. The multi-round dialog includes the first-round dialog that includes generating an answer text of the first-round dialog through the second large language model based on the question instruction of the first-round dialog. The multi-round dialog includes one or more subsequent-round dialogs, each round of the one or more subsequent-round dialogs including generating a question instruction of a current-round dialog through the third large language model based on an answer text of a previous-round dialog and generating an answer text of the current-round dialog through the second large language model based on the question instruction of the current-round dialog. In the method, sample data is constructed based on the question instructions in the multi-round dialog and the answer texts in the multi-round dialog, the sample data for training a target large language model.

According to an aspect, an embodiment of this disclosure provides a sample data generation method, performed by an electronic device, including: acquiring a first prompt text, and invoking a first large language model to perform question instruction prediction based on the first prompt text, to generate an initial question instruction; determining a question instruction of a first-round dialog based on the initial question instruction to perform a multi-round dialog, in each round of dialog, a second large language model being invoked to generate an answer text of a current-round dialog according to a question instruction of the current-round dialog, and in a dialog starting from a second round, a third large language model being invoked to generate a question instruction of a current-round dialog according to an answer text of a previous-round dialog; and constructing sample data based on a question instruction in the multi-round dialog and an answer text in the multi-round dialog.

According to another aspect, an embodiment of this disclosure further provides a sample data generation apparatus, including: a first generation module, configured to acquire a first prompt text, and invoke a first large language model to perform question instruction prediction based on the first prompt text, to generate an initial question instruction; a second generation module, configured to determine a question instruction of a first-round dialog based on the initial question instruction to perform a multi-round dialog, in each round of dialog, a second large language model being invoked to generate an answer text of a current-round dialog according to a question instruction of the current-round dialog, and in a dialog starting from a second round, a third large language model being invoked to generate a question instruction of a current-round dialog according to an answer text of a previous-round dialog; and a sample construction module, configured to construct sample data based on a question instruction in the multi-round dialog and an answer text in the multi-round dialog.

According to another aspect, an embodiment of this disclosure further provides an electronic device, including a memory (e.g., including a non-transitory computer-readable storage medium) and processing circuitry (e.g., a processor). The memory has a computer program stored therein, and the processor, when executing the computer program, implements the foregoing sample data generation method.

According to another aspect, an embodiment of this disclosure further provides a non-transitory computer-readable storage medium. The non-transitory storage medium has a computer program stored therein, and the computer program, when executed by processing circuitry (e.g., a processor), implements the foregoing sample data generation method.

According to another aspect, an embodiment of this disclosure further provides a computer program product. The computer program product includes a computer program, and the computer program is stored in a non-transitory computer-readable storage medium. Processing circuitry (e.g., a processor) of an electronic device reads the computer program from the non-transitory computer-readable storage medium, and the processor executes the computer program to enable the electronic device to perform the foregoing sample data generation method.

Various features and advantages of this disclosure will be described in the following description.

### BRIEF DESCRIPTION OF THE DRAWINGS

To describe technical solutions in various embodiments of this disclosure, the following briefly describes the drawings for describing the embodiments in this disclosure. The accompanying drawings in the following descriptions show merely non-limiting embodiments of this disclosure, and a person of ordinary skill in the art may obtain other accompanying drawings according to the disclosed accompanying drawings.

FIG. 1 is a schematic diagram of an implementation environment according to an embodiment of this disclosure.

FIG. 2 is a schematic flowchart of a sample data generation method according to an embodiment of this disclosure.

FIG. 3 is a first schematic structural diagram of a first large language model according to an embodiment of this disclosure.

FIG. 4 is a schematic structural diagram of a multi-round dialog according to an embodiment of this disclosure.

FIG. 5 is a schematic structural diagram of a task tree according to an embodiment of this disclosure.

FIG. 6 is an interface schematic diagram of a task configuration interface according to an embodiment of this disclosure.

FIG. 7 is another interface schematic diagram of a task configuration interface according to an embodiment of this disclosure.

FIG. 8 is a second schematic structural diagram of a first large language model according to an embodiment of this disclosure.

FIG. 9 is a third schematic structural diagram of a first large language model according to an embodiment of this disclosure.

FIG. 10 is a schematic architecture diagram of a sample data generation method according to an embodiment of this disclosure.

FIG. 11 is a schematic structural diagram of a sample data generation apparatus according to an embodiment of this disclosure.

FIG. 12 is a partial block diagram of a terminal according to an embodiment of this disclosure.

FIG. 13 is a partial block diagram of a server according to an embodiment of this disclosure.

### DESCRIPTION OF EMBODIMENTS

Technical solutions in one or more embodiments of this disclosure are described in the following with reference to accompanying drawings. The described embodiments are merely some rather than all embodiments of this disclosure. Based on the embodiments in this disclosure, other embodiments are within the scope of this disclosure.

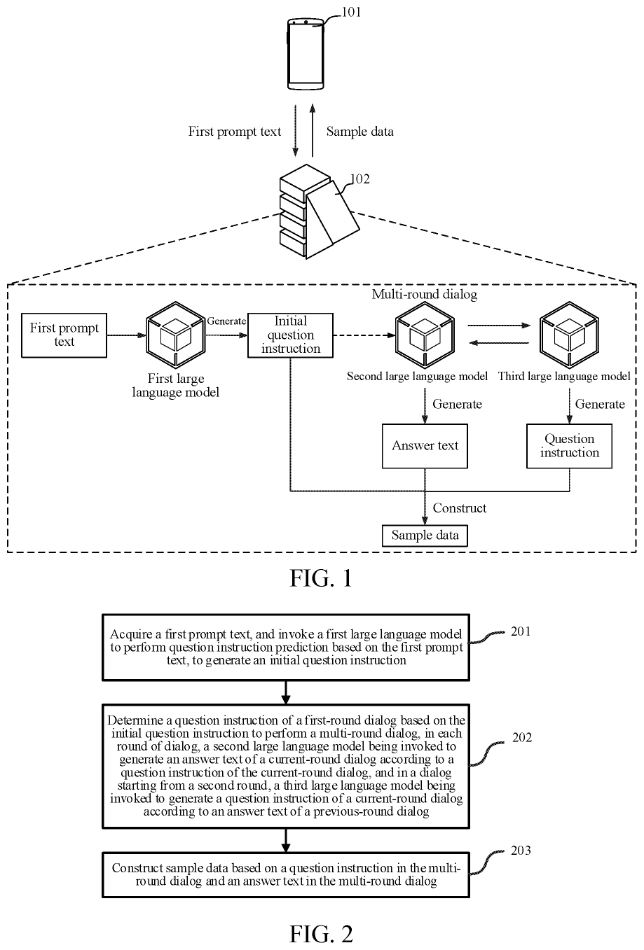

FIG. 1 is a schematic diagram of an implementation environment according to an embodiment of this disclosure. The implementation environment includes a terminal 101 and a server 102. The terminal 101 is connected with the server 102 through a communication network.

For example, the server 102 may acquire a first prompt text that is transmitted by the terminal 101 and that is configured for prompting a first large language model to generate a question instruction, and invoke the first large language model to perform question instruction prediction based on the first prompt text, to generate an initial question instruction; determine a question instruction of a first-round dialog based on the initial question instruction to perform a multi-round dialog, in each round of dialog, a second large language model being invoked to generate an answer text of a current-round dialog according to a question instruction of the current-round dialog, and in a dialog starting from a second round, a third large language model being invoked to generate a question instruction of a current-round dialog according to an answer text of a previous-round dialog; and construct sample data based on a question instruction in the multi-round dialog and an answer text in the multi-round dialog, and transmit the sample data to the terminal 101.

The server 102 generates the initial question instruction by using the first large language model, and then determines, according to the initial question instruction, a question instruction that is first input into the second large language model, which is equivalent to that the initial question instruction is used as a starting point of the multi-round dialog, and the multi-round dialog is performed by using the second large language model and the third large language model, so that answer texts and question instructions of a plurality of dialog rounds can be obtained, and then sample data is constructed by using the initial question instruction, the question instruction, and the answer text. Because the first large language model can generate high-quality and diversified initial question instructions, and the second large language model can generate high-quality and diversified answer texts, and the third large language model can generate high-quality and diversified question instructions, complexity and diversity of the question instructions can be improved by combining a plurality of large language models, thereby efficiently obtaining high-quality and diversified sample data.

The server 102 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In addition, the server 102 may alternatively be a node server in a blockchain system.

The terminal 101 may be a mobile phone, a computer, a smart voice interaction device, a smart home appliance, a vehicle terminal, or the like, but is not limited thereto. The terminal 101 and the server 102 may be directly or indirectly connected in a wired or wireless communication protocol. This is not limited in this application.

The method provided in this disclosure may be applied to various scenarios, including, but not limited to, a cloud technology, artificial intelligence, smart transport, assisted driving, or the like.

FIG. 2 is a schematic flowchart of a sample data generation method according to an embodiment of this disclosure. The sample data generation method may be performed by a server, or may be performed by a terminal, or may be performed by a server in cooperation with a terminal. The sample data generation method includes, but is not limited to, the following operation 201 to operation 203.

Operation 201: Acquire a first prompt text, and invoke a first large language model to perform question instruction prediction based on the first prompt text, to generate an initial question instruction. For example, one or more initial question instructions are generated by a question instruction prediction based on a first prompt text through a first large language model.

The first prompt text is configured for prompting the first large language model to generate a question instruction. That is, the first prompt text can instruct the first large language model to generate a specific output. Text content generated by the first large language model may be affected by providing the first prompt text.

The first large language model is a pre-trained large language model. The large language model is a deep learning model trained by using a large amount of text data, and can generate a natural language text or understand meaning of a language text. The large language model may use a recurrent neural network (RNN) or variants such as a long short-term memory (LSTM) and a gated recurrent unit (GRU), to capture context information in a text sequence, thereby implementing tasks such as natural language text generation, language model evaluation, text classification, and sentiment analysis. In the field of natural language processing, large language models have been widely applied, for example, speech recognition, machine translation, automatic summarization, a dialog system, and intelligent question answering.

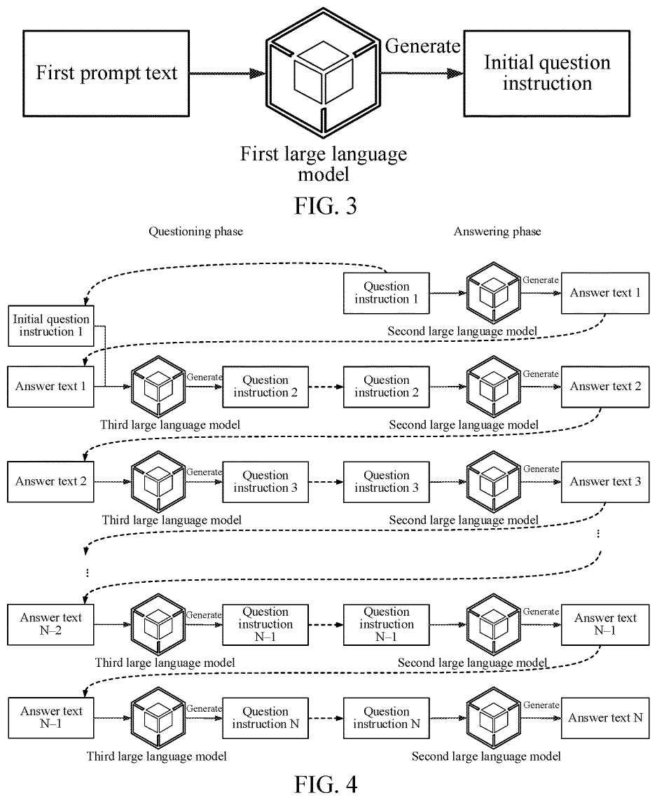

FIG. 3 is a first schematic structural diagram of a first large language model according to an embodiment of this disclosure.

The first prompt text is input into the first large language model, and the initial question instruction is generated by using the first large language model, so that accuracy of the initial question instruction can be improved, and generation quality is relatively high. In addition, the initial question instruction generated by the first large language model may be randomly determined or selected, which is equivalent to that the first large language model can generate high-quality and diversified question instructions.

Operation 202: Determine a question instruction of a first-round dialog based on the initial question instruction to perform a multi-round dialog, in each round of dialog, a second large language model being invoked to generate an answer text of a current-round dialog according to a question instruction of the current-round dialog, and in a dialog starting from a second round, a third large language model being invoked to generate a question instruction of a current-round dialog according to an answer text of a previous-round dialog.

For example, a question instruction of a first-round dialog of a multi-round dialog is determined based on the one or more initial question instructions. In some examples, the multi-round dialog is conducted through a second large language model and a third large language model. In some examples, the multi-round dialog includes the first-round dialog that includes generating an answer text of the first-round dialog through the second large language model based on the question instruction of the first-round dialog. In some examples, the multi-round dialog includes one or more subsequent-round dialogs, each round of the one or more subsequent-round dialogs including generating a question instruction of a current-round dialog through the third large language model based on an answer text of a previous-round dialog and generating an answer text of the current-round dialog through the second large language model based on the question instruction of the current-round dialog. In some examples, the multi-round dialog is stopped when a round count of the multi-round dialog is equal to a preset round count threshold.

The second large language model is configured to generate an answer text according to an input question instruction, and the third large language model is configured to generate, according to the answer text, a question instruction input into the second large language model. The second large language model is a pre-trained large language model. Therefore, the answer text is generated by using the second large language model, so that accuracy of the answer text can be improved, and generation quality is relatively high. The third large language model is a pre-trained large language model. Therefore, the question instruction is generated by using the third large language model, accuracy of the question instruction can be improved, and generation quality is relatively high.

Based on this, determining, according to the initial question instruction, a question instruction that is first input into the second large language model is equivalent to using the initial question instruction as a starting point of the multi-round dialog. The second large language model generates the answer text during an answering phase, and the answer text generated by the second large language model may vary. The third large language model generates the question instruction during a questioning phase, and the question instruction generated by the third large language model may vary. Therefore, high-quality and diversified answer texts and question instructions can be generated under interaction of the second large language model and the third large language model.

In at least one embodiment, one of the second large language model and the third large language model may be the same large language model as the first large language model.

In a possible implementation, before the determining a question instruction of a first-round dialog based on the initial question instruction to perform a multi-round dialog, the sample data generation method further includes: acquiring a first role definition text and a second role definition text, the first role definition text being configured for prompting the second large language model to act as an answerer for a target task in the multi-round dialog, the second role definition text being configured for prompting the third large language model to act as a questioner in the multi-round dialog, and the target task being a downstream task for training based on sample data; and inputting the first role definition text into the second large language model, and inputting the second role definition text into the third large language model. In some examples, the second large language model is configured to act as an answerer for a target task in the multi-round dialog based on a first role definition text; and the third large language model is configured to act as a questioner in the multi-round dialog based on a second role definition text. In some examples, the target task is executable by the target large language model that is trained based on the sample data.

The target task is a downstream task in a specific application field. For example, the target task may be about code generation of JavaScript in front-end development, and the target task may be solution generation of travel planning. Content of the first role definition text is configured for displaying a role that defines the second large language model, and content of the second role definition text is configured for displaying a role that defines the third large language model.

Based on this, before the determining a question instruction of a first-round dialog based on the initial question instruction to perform a multi-round dialog, the first role definition text is input into the second large language model, to prompt the second large language model to act as the answerer for the target task in the multi-round dialog, and the second large language model can better understand an answer generation task in the multi-round dialog, so that generation quality of the answer text can be improved. In addition, the second large language model can generate an answer text related to the target task, and subsequently obtain sample data related to the target task. The large language model is trained by using the sample data related to the target task, to implement fine-tuning on the large language model. The fine-tuned large language model can better adapt to the target task, thereby helping improve performance of the large language model in a specific application field.

In addition, the second role definition text is input into the third large language model, to prompt the third large language model to act as the questioner in the multi-round dialog, and the third large language model can better understand a question instruction generation task in the multi-round dialog, so that generation quality of the question instruction can be improved.

For example, when the target task is about code generation of JavaScript in front-end development, the second role definition text may be “System role: You are a front-end development engineer with rich experience, especially good at JavaScript programming. I ask you some questions about code generation of JavaScript in front-end development, and you need to provide detailed answers”. The first role definition text may be “System role: You are interacting with a front-end code programming assistant, the front-end code programming assistant provides an answer, and you need to output a question instruction”.

Inputting the first role definition text into the second large language model is equivalent to endowing the second large language model with a role of an answerer, and inputting the second role definition text into the third large language model is equivalent to endowing the third large language model with a role of a questioner. The third large language model interacts with the second large language model by simulating a questioning operation of a related person, to invoke the second large language model and the third large language model to perform the multi-round dialog. In a real scenario, a reliable dialog assistant usually needs to have a capability of performing the multi-round dialog with an object, and can understand and resolve a question of the object based on the multi-round dialog. Therefore, the multi-round dialog is performed by using the second large language model and the third large language model, and data of the multi-round dialog is constructed, thereby better imitating a real dialog scenario, and subsequently obtaining high-quality sample data.

In a possible implementation, the second role definition text may be configured for prompting the third large language model to act as a questioner for a target task in the multi-round dialog. The third large language model can generate a question instruction related to the target task, and subsequently obtain sample data related to the target task. A large language model is trained by using sample data related to the target task, to implement fine-tuning on the large language model. The fine-tuned large language model can better adapt to the target task, helping improve performance of the large language model in a specific application field.

In a possible implementation, after obtaining the answer text of the first dialog round, the sample data generation method may further include: constructing a second prompt text configured for prompting the third large language model to generate a question instruction according to the answer text each time the answer text is received; inputting the second prompt text and the answer text of a first dialog round into the third large language model to perform question instruction prediction, to generate a question instruction of a second-round dialog; and stopping the multi-round dialog when a round count of the multi-round dialog is equal to a preset round count threshold.

In some examples, a second prompt text on which the third large language model is based to generate the question instruction of a second-round dialog of the multi-round dialog is constructed. In some examples, the question instruction of the second-round dialog is generated through the third large language model based on the second prompt text and the answer text of the first-round dialog.

In at least one embodiment, the determining the question instruction of the first-round dialog based on the initial question instruction to perform the multi-round dialog may include: inputting the initial question instruction into the second large language model to perform answer prediction, to generate an answer text of the first dialog round; constructing a second prompt text configured for prompting the third large language model to generate a question instruction according to the answer text each time the answer text is received; inputting the second prompt text and the answer text of the first dialog round into the third large language model to perform question instruction prediction, to generate a question instruction of a next dialog round; and inputting the question instruction of the next dialog round into the second large language model to perform answer prediction again, until a round count of the dialog round is equal to a preset round count threshold.

The round threshold is a preset dialog round count. For example, the round count threshold may be set to 5, or set to another value. Inputting the initial question instruction to the second large language model to perform answer prediction may include: using a set of a plurality of initial question instructions as a seed instruction set. The initial question instructions in the seed instruction set may be considered as seed instructions. The initial question instructions that are input into the second large language model may be sequentially selected from the seed instruction set, or the initial question instructions that are input into the second large language model may be randomly selected from the seed instruction set.

Based on this, the initial question instruction is used as the question instruction of the first dialog round, and after the initial question instruction is input into the second large language model, the second large language model answers the initial question instruction, to generate an answer text. It is assumed that the initial question instruction is a question proposed for a particular downstream task, and the answer text is an answer made for the downstream task. Then the second prompt text and the answer text of the first dialog round are input into the third large language model, to generate a question instruction of a next dialog round. The second prompt text can prompt the third large language model to generate the question instruction according to the answer text, so the question instruction is a question proposed for the downstream task. In a subsequent dialog round, the answer text generated by the second large language model and the question instruction generated by the third large language model may be considered to be for the same downstream task. Subsequently, sample data related to the downstream task can be obtained, and the large language model is trained by using the sample data related to the downstream task, to implement fine-tuning on the large language model. The fine-tuned large language model can better adapt to the downstream task, helping improve performance of the large language model in a specific application field.

In at least one embodiment, the second prompt text is input into the third large language model while inputting the answer text of the first dialog round into the third large language model, so that the third large language model can understand a question instruction generation task. The second prompt text may be input again when an answer text of a subsequent dialog round is input into the third large language model. Because the third large language model has a relatively strong context processing capability, and the third large language model considers the second prompt text that is previously input when a new question instruction is generated, the second prompt text does not need to be input again.

For example, the second prompt text may be “You need to provide a question instruction in combination with a response of the other party”. When the target task is about code generation of JavaScript in front-end development, the second prompt text may alternatively be “You need to provide a question instruction in combination with a response of the other party, for example, any question instruction related to code generation of JavaScript in front-end development”.

In a possible implementation, inputting the second prompt text and the answer text of the first dialog round into the third large language model to perform question instruction prediction, to generate the question instruction of the next dialog round may include: adding the initial question instruction to the second prompt text, to obtain a fusion prompt text; and inputting the fusion prompt text and the answer text of the first dialog round into the third large language model to perform question instruction prediction, to generate the question instruction of the next dialog round. For example, the one or more initial question instructions from Operation 201 are to the second prompt text, to obtain a fusion prompt text. In some examples, the fusion prompt text and the answer text of the first-round dialog are inputted into the third large language model, to generate the question instruction of the second-round dialog.

The fusion prompt text is configured for prompting the third large language model to generate a question instruction according to each question instruction input into the second large language model and the answer text of each dialog round; adding the initial question instruction to the second prompt text is equivalent to updating the second prompt text to obtain the fusion prompt text; and the fusion prompt text is input into the third large language model, so that when the third large language model needs to refer to the answer text and the question instruction of each historical dialog round when generating the question instruction.

FIG. 4 is a schematic structural diagram of a multi-round dialog according to an embodiment of this disclosure.

Because the initial question instruction is equivalent to the question instruction of the first dialog round, when the third large language model generates a question instruction of a second dialog round, the initial question instruction belongs to a question instruction of a historical dialog round, and the fusion prompt text needs to include the initial question instruction. Then the fusion prompt text and the answer text of the first dialog round are input into the third large language model, and the third large language model can generate the question instruction of the second dialog round according to the initial question instruction and the answer text of the first dialog round.

It is assumed that the initial question instruction is a question proposed for a particular downstream task, and the answer text corresponding to the initial question instruction is an answer made for the downstream task. The third large language model generates the question instruction according to the question instruction and the answer text of each dialog round, so that the newly generated question instruction is a question proposed for the downstream task. The newly generated question instruction can be closer to a real question instruction of a related person, sample data related to the downstream task can be subsequently obtained, and the large language model is trained by using the sample data related to the downstream task, to implement fine-tuning on the large language model. The fine-tuned large language model can better adapt to the downstream task, helping improve performance of the large language model in a specific application field.

For example, when the target task is about code generation of JavaScript in front-end development, the initial question instruction may be “How to implement an image carousel function by using JavaScript?”. The initial question instruction is added to the second prompt text, so that the fusion prompt text can be obtained.

The fusion prompt text may be “You have an initial question: How to implement an image carousel function by using JavaScript? You need to provide a question instruction with reference to replies of the other party; you need to provide a question instruction in combination with a response of the other party, for example: 1, a question related to a previous question instruction; 2, a further question is proposed for a previous answer of the other party; and 3, any question instruction related to code generation of JavaScript in front-end development”.

In addition, a format of the newly generated question instruction may further be defined in the fusion prompt text. For example, a requirement that “Your output format is: Instruction: XXXX” is added to the fusion prompt text.

Operation 203: Construct sample data based on a question instruction in the multi-round dialog and an answer text in the multi-round dialog. For example, sample data is constructed based on the question instructions in the multi-round dialog and the answer texts in the multi-round dialog, the sample data for training a target large language model.

Based on this, the sample data is constructed by using the initial question instruction, the question instruction, and the answer text. Because the first large language model can generate high-quality and diversified initial question instructions, the second large language model can generate high-quality and diversified answer texts, and the third large language model can generate high-quality and diversified question instructions, complexity and diversity of the question instructions can be improved by combining a plurality of large language models, thereby efficiently obtaining high-quality and diversified sample data.

Therefore, a large language model may be subsequently trained by using the sample data, to implement fine-tuning on the large language model, helping improve performance of the large language model in a specific application field, and activating a large language model that can correctly understand various instructions and can provide high-quality responses.

In a possible implementation, acquiring the first prompt text may specifically include: acquiring task information of a target task, the target task being a downstream task for training based on the sample data; and constructing, based on the task information, the first prompt text configured for prompting the first large language model to generate the question instruction according to the task information. For example, task information of a target task is acquired, where the target task is executable by the target large language model that is trained based on the sample data. In some examples, the first prompt text on which the first large language model is based to generate the one or more initial question instructions is constructed based on the task information.

Based on this, the target task is a downstream task in a specific application field. The first prompt text is constructed based on the task information of the target task, and the sample data related to the target task can be subsequently obtained. The large language model is trained by using the sample data related to the target task, to implement fine-tuning on the large language model. The fine-tuned large language model can better adapt to the target task, helping improve performance of the large language model in a specific application field.

In at least one embodiment, a preset first prompt template may be filled with task content included in the task information, to obtain the first prompt text. For example, it is assumed that the task information of the target task is “Generate JavaScript code used in front-end development”, the task content included in the task information includes code generation, front-end development, and JavaScript, the first prompt template may be “Please provide some <task content>question instructions”, the task content included in the task information is correspondingly constructed based on a preset prompt construction policy, and <task content> in the first prompt template is filled with a construction result, to obtain the first prompt text as “Please provide some question instructions related to code generation of JavaScript in front-end development”.

In a possible implementation, constructing, based on the task information, the first prompt text configured for prompting the first large language model to generate the question instruction according to the task information may include: determining, in a preset task tree according to the task information, a target node matching the task information, the task tree including a plurality of levels of nodes, and each node carrying (or specifying) a respective candidate keyword; and using the candidate keyword carried in the target node as a target keyword, and constructing, according to the target keyword, the first prompt text configured for prompting the first large language model to generate the question instruction according to the task information. For example, the first prompt text is constructed based on a target keyword that is the candidate keyword specified by the target node.

The task tree includes a plurality of levels of nodes. The candidate keyword carried in each node is configured for indicating specific task content of the target task. Two nodes that have a parent-child relationship in the task tree are connected to each other. Based on a connection relationship between the nodes, each node may correspond to a specific downstream task. If the two nodes in the task tree have a parent-child relationship, downstream tasks corresponding to the two nodes have a hierarchical relationship. Task granularity ranges corresponding to the nodes at different levels are usually different, and task granularity ranges corresponding to the nodes at the same level are usually the same.

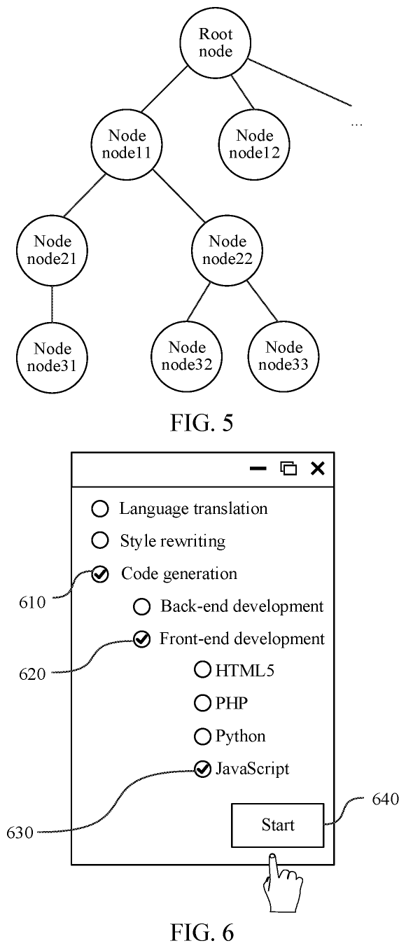

FIG. 5 is a schematic structural diagram of a task tree according to an embodiment of this disclosure.

It is assumed that a candidate keyword carried in a node node11 serving as a parent node is code generation, it is assumed that a child node corresponding to the node node11 includes a node node22, a candidate keyword carried in the node node22 may be mathematical reasoning, which is equivalent to that a downstream task task11 corresponding to the node node11 is a code generation task, and a downstream task task22 corresponding to the node node22 is a code generation task about mathematical reasoning. The downstream task task22 may be considered as a sub-task of the downstream task task11, there is a hierarchical relationship between the downstream task task22 and the downstream task task11, and the downstream task task22 is a more specific task than the downstream task task11, that is, a task granularity range of the downstream task task22 is smaller than a task granularity range of the downstream task task11. Therefore, task granularity ranges corresponding to the nodes at different levels are different.

Further, it is assumed that a child node corresponding to the node node22 includes a node node32 and a node node33, a candidate keyword carried in the node node32 may be a junior-school mathematical question, and a candidate keyword carried in the node node33 may be a high-school mathematical question, which is equivalent to that a downstream task task32 corresponding to the node node32 is a code generation task for mathematical reasoning about the junior-school mathematical question, and a downstream task task33 corresponding to the node node33 is a code generation task for mathematical reasoning about the high-school mathematical question. The downstream task task32 and the downstream task task33 may both be considered as sub-tasks of the downstream task task22. There is a hierarchical relationship between the downstream task task32 and the downstream task task22 and between the downstream task task33 and the downstream task task22, and task granularity ranges of the downstream task task32 and the downstream task task33 are the same. Therefore, the task granularity ranges corresponding to nodes at the same level are the same.

There are a plurality of manners for determining a target node. Two of the manners are described in detail below.
Manner 1: FIG. 6 is an interface schematic diagram of a task configuration interface according to an embodiment of this disclosure.

The task configuration interface may be configured with a plurality of first check box controls 610, a plurality of second check box controls 620, a plurality of third check box controls 630, and a first configuration determining control 640. The task configuration interface may further be configured with more levels of check box controls. This is not limited in this disclosure.

Using check box controls of three levels as an example, each check box control has a corresponding task content, and text of the corresponding task content is displayed on one side of each check box control. The first check box controls 610, the second check box controls 620, and the third check box controls 630 respectively correspond to nodes at different levels of a task tree. Each first check box control 610 has an association relationship with a corresponding node located at a second level, each second check box control 620 has an association relationship with a corresponding node located at a third level, and each third check box control 630 has an association relationship with a corresponding node located at a fourth level. Therefore, there is a hierarchical relationship among the first check box control 610, the second check box control 620, and the third check box control 630.

The plurality of first check box controls 610 are usually presented on a task configuration interface of a terminal. A related person may click any presented first check box control 610 on the task configuration interface. At most one first check box control 610 is allowed to be in a check state at a moment. When one first check box control 610 is in the check state, the second check box controls 620 at a next level of the first check box control 610 are presented on the task configuration interface.

The related person may click any presented second check box control 620 on the task configuration interface. At most one second check box control 620 is allowed to be in a check state at a moment. When one second check box control 620 is in the check state, the third check box controls 630 at a next level of the second check box control 620 are presented on the task configuration interface.

The related person may click any presented third check box control 630 on the task configuration interface, and at most one third check box control 630 is allowed to be in a check state at a moment.

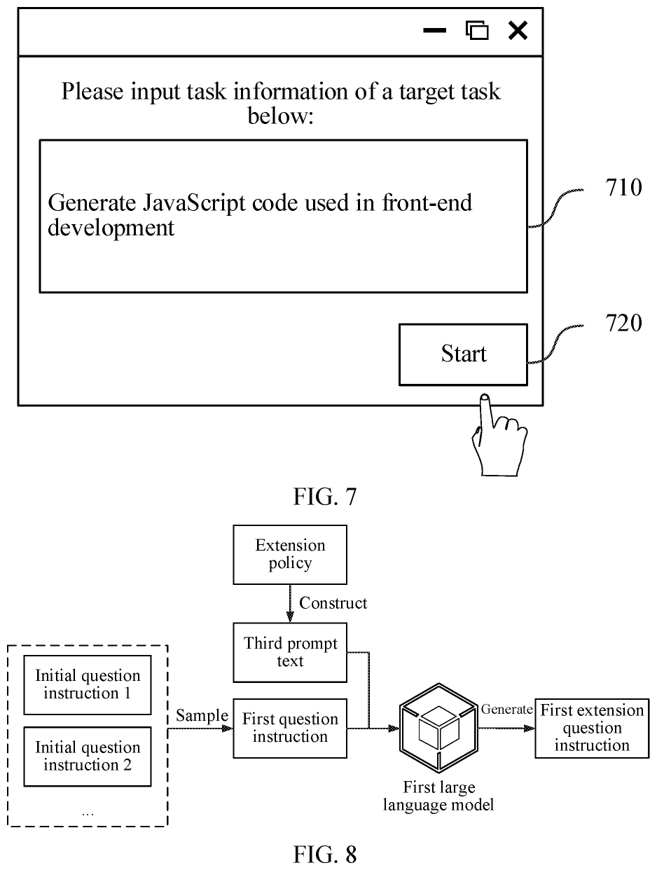

After completing checking, the related person may trigger the first configuration determining control 640. The related person may trigger the first configuration determining control 640 after selecting the first check box control 610, or may trigger the first configuration determining control 640 after selecting the first check box control 610 and selecting the second check box control 620. The first configuration determining control 640 is triggered, so that the terminal can determine a target node in the task tree according to check states of the check box controls in response to an operation on the first configuration determining control 640, and use a node corresponding to the last check box control in the check state as the target node. In FIG. 6, the first check box control 610 having a task content of code generation is in the check state, the second check box control 620 having a task content of front-end development is in the check state, and the third check box control 630 having a task content of front-end JavaScript is in the check state. Therefore, a target node of JavaScript can be determined in the task tree.
Manner 2: FIG. 7 is another interface schematic diagram of a task configuration interface according to an embodiment of this disclosure.

The task configuration interface may be configured with a text input control 710 and a second configuration determining control 720.

In a task configuration interface of a terminal, a related person may input task information of a target task by using the text input control 710, and then the related person may trigger the second configuration determining control 720. The second configuration determining control 720 is triggered, so that the terminal can determine a target node in a task tree according to the task information in the text input control 710 in response to an operation on the second configuration determining control 720.

In at least one embodiment, it is assumed that the task information is “Generate related code of JavaScript in front-end development”. Referring to FIG. 5, a node matching the task information is first determined in nodes at a second level of the task tree. It is assumed that a node matching the second level is a node node11, for example, a candidate keyword carried in the node node11 is code generation, and then a node matching the task information is determined in child nodes of the node node11. It is assumed that a node matching a third level is a node node21, for example, a candidate keyword carried in the node node21 is front-end development, and then a node matching the task information is determined in child nodes of the node node21. It is assumed that a node matching a fourth level is a node node31, for example, a candidate keyword carried in the node node31 is JavaScript, and then a node matching the task information is determined in child nodes of the node node31. It is assumed that the fourth level does not have a matching node, the node node31 is used as the target node.

In the nodes matching the task information, a task granularity range corresponding to the target node is the smallest. The candidate keyword carried in the target node is used as a target keyword, and a task content indicated by the target keyword is the most specific. Because the first prompt text is constructed according to the target keyword, the first prompt text can prompt the first large language model to generate an initial question instruction for the target task. For example, the target keyword carried in the target node is JavaScript, and the constructed first prompt text may be “Please provide some question instructions related to JavaScript”.

In a possible implementation, the constructing, according to the target keyword, the first prompt text configured for prompting the first large language model to generate the question instruction according to the task information may include:
constructing, when a level at which the target node is located is a target level and according to the target keyword, the first prompt text configured for prompting the first large language model to generate the question instruction according to the task information, the target level being a level subsequent to a level at which a root node in the task tree is located, where
whether the level at which the target node is located belongs to the target level is determined after the target node matching the task information is determined in the task tree, the task information only matches the target node in the task tree in a case that the level at which the target node is located is the target level, and the task information can be accurately represented by using the target keyword, so the first prompt text is constructed according to the target keyword; or
determining, in the task tree when the level at which the target node is located is the level subsequent to the target level, an associated node associated with the target node, using the candidate keyword carried in the associated node as an associated keyword, and constructing, according to the associated keyword and the target keyword, the first prompt text configured for prompting the first large language model to generate the question instruction according to the task information, a level at which the associated node is located being previous to the level at which the target node is located, where
the task information matches a plurality of nodes in the task tree in a case that the level at which the target node is located is the level subsequent to the target level, an associated node associated with the target node needs to be determined, then a candidate keyword of the associated node is used as the associated keyword, and the task information can be accurately represented by using a combination of the associated keyword and the target keyword, so that the first prompt text is constructed according to the associated keyword and the target keyword.

In some examples, a level at which the target node is located is a target level that is a level subsequent to a level at which a root node in the task tree is located. In some examples, an associated node associated with the target node in the task tree is determined, when a level at which the target node is located is a level subsequent to a target level, the target level is a level subsequent to a level at which a root node in the task tree is located, and a level at which the associated node is located preceding the level at which the target node is located. In some examples, the first prompt text is constructed based on the target keyword and an associated keyword that is the candidate keyword specified by the associated node.

For example, the target level is the level subsequent to the level at which the root node in the task tree is located, that is, the target level is a second level. It is assumed that the level at which the target node is located is a fourth level, that is, the level at which the target node is located is the level subsequent to the target level, a node connected to the target node may be determined as a first associated node in a third level, a node connected to the first associated node may be determined as a second associated node in the target level, and then the first prompt text is constructed according to associated keywords carried in the two associated nodes and the target keyword carried in the target node. The first prompt text can prompt the first large language model to generate the initial question instruction for the target task more specifically. For example, the target keyword carried in the target node is JavaScript, the associated keyword carried in the first associated node is front-end development, the associated keyword carried in the second associated node is code generation, and the constructed first prompt text may be “Please provide some question instructions related to code generation of JavaScript in front-end development”.

In a possible implementation, the level subsequent to the level at which the root node in the task tree is located is the target level, a node located at the target level carries a third role definition text, and before using the candidate keyword carried in the target node as the target keyword, the sample data generation method further includes: using a node that is associated with the target node and that is located at the target level as a target role definition node, and using the third role definition text carried in the target role definition node as a target role definition text, the target role definition text being configured for prompting the first large language model to act as a questioner for the target task; and inputting the target role definition text to the first large language model. For example, a node that is associated with the target node and located at the target level is determined as a target role definition node, and a third role definition text specified by the target role definition node is determined as a target role definition text. In some examples, the first large language model is configured to act as a questioner for the target task based on the third role definition text.

Based on this, the target level of the task tree may include one or more nodes, and the node located at the target level in the task tree is used as a role definition node. Because different role definition nodes carry different candidate keywords, which is equivalent to that different role definition nodes corresponding to different specific task contents, a third role definition text corresponding to each role definition node needs to be configured, and a content of the third role definition text is configured for displaying a role that defines the first large language model. In addition, because a task granularity range corresponding to the role definition node in the task tree is the largest, the task granularity range corresponding to another node associated with the role definition node is within a sub-range of the task granularity range corresponding to the role definition node. Therefore, the target role definition text may be adapted to the target role definition node and another node associated with the target role definition node. The target role definition text is input into the first large language model, so that the first large language model can better understand the target task, and generation quality of the initial question instruction can be improved.

Referring to FIG. 5 again, it is assumed that the candidate keyword carried in the role definition node node11 is code generation, and the third role definition text configured by the role definition node node11 may be “System role: You are an assistant good at code programming and related to a question”. For another example, a candidate keyword carried in the role definition node node12 is travel planning, and the third role definition text configured by the role definition node node12 may be “System role: You are a virtual tour guide good at travel planning”.

It is assumed that the role definition node node11 is a target role definition node, and the target role definition text is “System role: You are an assistant good at code programming and related to a question”, the target role definition text is input into the first large language model, so that the first large language model can better understand a target task of code generation, and generation quality of an initial question instruction can be improved.

In a possible implementation, there are a plurality of initial question instructions, and before the determining a question instruction of a first-round dialog based on the initial question instruction to perform a multi-round dialog, the sample data generation method further includes: randomly sampling a first question instruction from the plurality of initial question instructions; constructing, based on a preset extension policy, a third prompt text configured for prompting the first large language model to perform instruction extension according to the extension policy; and inputting the third prompt text and the first question instruction into the first large language model, performing instruction extension on the first question instruction, to generate a first extension question instruction, and using the first extension question instruction as the initial question instruction. For example, a third prompt text is constructed based on one or more extension policies; and a first extension question instruction is generated, as the question instruction of the first-round dialog, through the first large language model based on the third prompt text and the first question instruction.

FIG. 8 is a second schematic structural diagram of a first large language model according to an embodiment of this disclosure.

The randomly sampling the first question instruction from the plurality of initial question instructions may include: using a set of a plurality of initial question instructions generated by the first large language model as a seed instruction set. The initial question instructions of the seed instruction set may be considered as seed instructions, and the first question instructions are randomly sampled from the seed instruction set; the extension policy may be a policy text that complicates a question instruction; the extension policy is configured for prompting the first large language model how to complicate the question instruction; and the extension policy may be configured for making a requirement on a first extension question instruction generated by the first large language model, for example, the extension policy may make a word count requirement, a word usage requirement, a reasoning operation count requirement, a complexity requirement, or the like on the first extension question instruction. Different downstream tasks usually require different extension policies. Therefore, a plurality of extension policies need to be preset to deal with different downstream tasks.

Based on this, the third prompt text is constructed based on the extension policy. The third prompt text can prompt the first large language model to process a question instruction complication task. The third prompt text and the first question instruction are input into the first large language model, so that the first large language model can perform question instruction complication on the first question instruction. The first large language model can generate the first extension question instruction based on a model input. There may be one or more first extension question instructions. This is not limited in this disclosure. The first extension question instruction may be considered as a question instruction complication result of the first question instruction. Because a related person may input a relatively complex question instruction, a first extension question instruction with relatively high complexity is usually closer to a relatively complex question instruction input by the related person in a real scenario compared with a first question instruction with relatively low complexity, so that a training effect of a large language model can be effectively improved when the large language model is trained by using the first extension question instruction in a subsequent downstream task.

In at least one embodiment, before the determining a question instruction of a first-round dialog based on the initial question instruction to perform a multi-round dialog, a plurality of first extension question instructions may be generated by using a plurality of complication rounds. In each complication round, the first question instruction needs to be randomly sampled from the plurality of initial question instructions, so that question instruction complication can be performed on part initial question instructions, and the first extension question instruction obtained by complicating the question instruction is used as the initial question instruction, so that diversity of the initial question instructions can be further improved, and a training effect of the large language model can be improved subsequently.

Using a downstream task about code generation of JavaScript in front-end development as an example, the first extension question instruction may be obtained in a plurality of manners. A process of obtaining the first extension question instruction is described in detail by using of the manners as an example.
Manner 1: It is assumed that the randomly sampled first question instruction is “How to implement an image carousel function by using JavaScript?”, and it is assumed that the extension policy is “Add a new constraint and requirement to an original instruction, and increase a content length of the instruction”, the third prompt text constructed based on the extension policy may be “Please increase complexity of a provided question instruction, and the complexity of the question instruction may be increased by using the following method: method 1: adding a new constraint and requirement to an original instruction, and increasing a content length of the instruction”.

A second prompt template is filled with the third prompt text and the first question instruction, and an obtained first input text is “Please increase complexity of a provided question instruction, and the complexity of the instruction may be increased by using the following method: method 1: adding a new constraint and requirement to an original instruction, and increasing a content length of the instruction. Original instruction: How to implement an image carousel function by using JavaScript?”.

Then the first input text is input into the first large language model, and the first large language model generates the first extension question instruction.

A content of the fourth role definition text is configured for displaying a role that defines the first large language model. Before inputting the first input text into the first large language model, the fourth role definition text is input into the first large language model, to prompt the first large language model to act as a questioner for the target task. For example, in a downstream task of code generation of JavaScript in front-end development, the fourth role definition text may be “System role: You are an assistant good at long code programming and related to a question”. The fourth role definition text is input into the first large language model, so that the first large language model can better understand the question instruction complication task, and generation quality of the second extension question instruction can be improved.

In a possible implementation, there are a plurality of extension policies, and performing instruction extension on the first question instruction, to generate the first extension question instruction may include: performing a plurality of instruction extensions on the first question instruction, to obtain the first extension question instruction generated by each instruction extension, where the instruction extension is performed on the first question instruction according to at least one of the plurality of extension policies each time the instruction extension is performed on the first question instruction. For example, a plurality of instruction extensions is performed on the first question instruction, to obtain a respective candidate first extension question instruction generated by each instruction extension, each instruction extension being performed on the first question instruction based on at least one of the plurality of extension policies.

Based on this, after inputting the third prompt text and the first question instruction into the first large language model, the first large language model performs a plurality of instruction extensions on the first question instruction. Therefore, a plurality of question instruction complications are performed on the same first question instruction, so that a plurality of first extension question instructions can be obtained. In addition, one or more of the extension policies are randomly selected to perform instruction extension on the first question instruction each time the instruction extension is performed, so that randomness and diversity of the first extension question instructions can be improved. Each first extension question instruction is used as the initial question instruction, so that diversity of the initial question instructions can be further improved.

In at least one embodiment, it is assumed that four extension policies are preset, an extension policy a is “Add a new constraint and requirement to an original instruction, and increase a content length of the instruction”, an extension policy b is “Replace a common concept in the original instruction with a more specific but less common concept”, an extension policy c is “Add a reasoning operation of the original instruction”, and an extension policy d is “Increase time complexity or space complexity of the original instruction”. The third prompt text constructed based on the extension policy may be “Please increase complexity of a provided question instruction, and ensure integrity of the question instruction, where methods for improving complexity of the question instruction include, but are not limited to: method 1: adding a new constraint and requirement to an original instruction, and increasing a content length of the instruction; method 2: replacing a common concept in the original instruction with a more specific but less common concept; method 3: adding a reasoning operation of the original instruction; and method 4: increasing time complexity or space complexity of the original instruction”.

In a possible implementation, there are a plurality of initial question instructions, and before determining a question instruction of a first-round dialog based on the initial question instruction to perform a multi-round dialog, the sample data generation method further includes: randomly sampling a second question instruction from the plurality of initial question instructions; and constructing a fourth prompt text configured for prompting the first large language model to generate the question instruction with reference to the second question instruction, inputting the fourth prompt text and the second question instruction into the first large language model to perform question instruction prediction, to generate a second extension question instruction, and using the second extension question instruction as the initial question instruction. For example, a fourth prompt text is constructed based on the second question instruction; and a second extension question instruction is generated, as the question instruction of the first-round dialog, through the first large language model based on the fourth prompt text and the second question instruction.

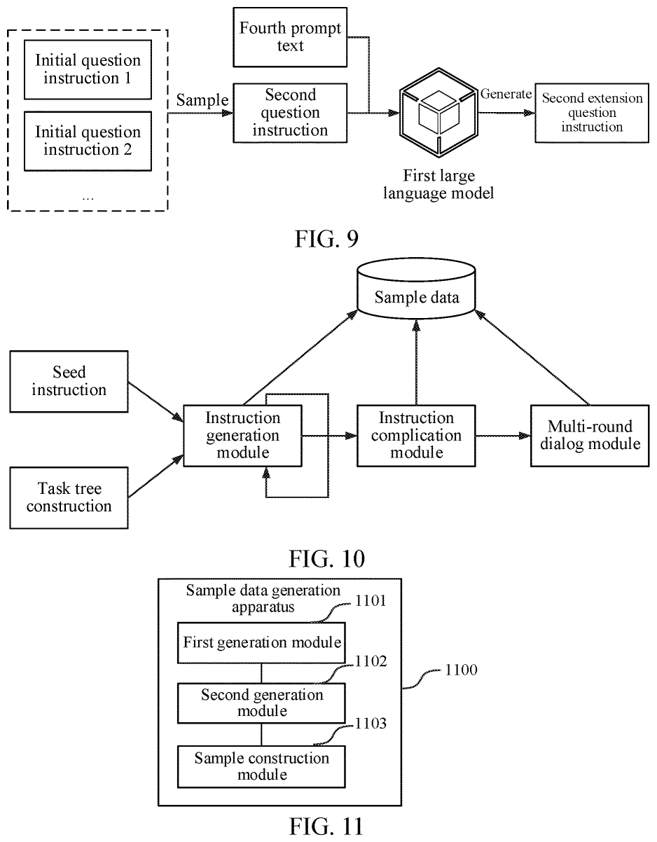

FIG. 9 is a third schematic structural diagram of a first large language model according to an embodiment of this disclosure.

The randomly sampling the second question instruction from the plurality of initial question instructions may include: using a set of a plurality of initial question instructions generated by the first large language model as a seed instruction set. The initial question instructions of the seed instruction set may be considered as seed instructions, and a preset quantity of question instructions are randomly sampled from the seed instruction set to obtain the second question instruction. Therefore, constructing the fourth prompt text configured for prompting the first large language model to generate the question instruction with reference to the second question instruction is equivalent to considering the second question instruction as a reference example of a question instruction generation task, and inputting the fourth prompt text and the second question instruction into the first large language model. The first large language model can generate a second extension question instruction based on a model input, then the second extension question instruction is used as a new initial question instruction, and then the new initial question instruction is added to the seed instruction set. There may be one or more second extension question instructions. This is not limited in this disclosure.

Based on this, under an effect of the fourth prompt text, the second question instruction is considered as a reference example. The first large language model is enabled to learn a task by using several reference examples organized in a demonstration form, and knowledge included in the second question instruction is temporarily inserted into the first large language model, so that the first large language model can better understand a current question instruction generation task, thereby generating a second extension question instruction with relatively good quality. Because the first large language model generates the second extension question instruction based on the knowledge included in the second question instruction, the knowledge included in the second extension question instruction is similar to the knowledge included in the second question instruction, which is equivalent to that the second extension question instruction and the second question instruction may be configured for processing the same downstream task. Therefore, the second extension question instruction may be used as a new initial question instruction, and the second extension question instruction generated by the first large language model is usually different from the second question instruction, that is, the first large language model can output a generalized instruction, so that the initial question instruction is effectively extended, and diversity of the initial question instructions can be increased.

In at least one embodiment, before the determining a question instruction of a first-round dialog based on the initial question instruction to perform a multi-round dialog, a plurality of second extension question instructions may be generated by using a plurality of generation rounds. In each generation round, the second question instruction needs to be randomly sampled from a plurality of initial question instructions. Because the second extension question instruction is used as the new initial question instruction, the second question instruction sampled in a current generation round may be a second extension question instruction generated in a previous generation round.

Using a downstream task about code generation of JavaScript in front-end development as an example, the second extension question instruction may be obtained in a plurality of manners. A process of obtaining the second extension question instruction is described in detail by using two of the manners as examples.
Manner 1: It is assumed that two second question instructions are randomly sampled, a second question instruction a is “How to implement an image carousel function by using JavaScript?”, a second question instruction b is “How to create a timer by using JavaScript?”, and the constructed fourth prompt text may be “The following are some question instructions related to code generation of JavaScript in front-end development”, where a specific form of the fourth prompt text is not limited in this disclosure.

A third prompt template is filled with the fourth prompt text and the second question instruction, and an obtained second input text is “The following are some question instructions related to code generation of JavaScript in front-end development. Sample 1: Instruction: How to implement an image carousel function by using JavaScript? Sample 2: Instruction: How to create a timer by using JavaScript? Sample 3:”; and
then the second input text is input into the first large language model, the first large language model generates the second extension question instruction, and it is assumed that an output of the first large language model is “Instruction: How to implement click event detection by using JavaScript?”, the second extension question instruction is “How to implement click event detection by using JavaScript?”.
Manner 2: It is assumed that two second question instructions are randomly sampled, a second question instruction a is “How to implement an image carousel function by using JavaScript?”, a second question instruction b is “How to create a timer by using JavaScript?”, and the constructed fourth prompt text may be “Please generate a new question instruction with reference to a question instruction related to code generation of JavaScript in front-end development”, where a specific form of the fourth prompt text is not limited in this disclosure.

The fourth prompt text, the second question instruction a, and the second question instruction b are sequentially concatenated, and an obtained first concatenated text is “Please generate a new question instruction with reference to the following question instruction related to code generation of JavaScript in front-end development. How to implement an image carousel function by using JavaScript? How to create a timer by using JavaScript?”; and
then the first concatenated text is input into the first large language model, the first large language model generates the second extension question instruction, and it is assumed that an output of the first large language model is “How to implement click event detection by using JavaScript?”, the second extension question instruction is “How to implement click event detection by using JavaScript?”.

In a possible implementation, before the invoking a first large language model to perform question instruction prediction based on the first prompt text, the sample data generation method further includes: acquiring a target sampling temperature value; and configuring a temperature parameter of the first large language model as the target sampling temperature value, where the target sampling temperature value being configured for indicating randomness degree of an output result of the first large language model.

The temperature parameter of the first large language model is a hyperparameter. The hyperparameter is a parameter configured for the first large language model before the first large language model starts learning. The hyperparameter is not obtained through model training, and the hyperparameter is usually configured for the first large language model by assigning a value based on existing experience. Because the initial question instruction generated by the first large language model is usually obtained by sampling a word list based on a probability distribution, the temperature parameter is configured for adjusting the probability distribution, and the target sampling temperature value may be manually input or preset.

Based on this, a larger target sampling temperature value indicates a smoother probability distribution, which is equivalent to smoothing initial probability of each token in the word list. Generation probability of a token with relatively low initial probability is increased, and randomness of the initial question instruction is increased, so that the initial question instructions are more diversified. However, the initial question instructions are more likely to have a quality problem, for example, inaccurate syntax or inaccurate content. On the contrary, a smaller target sampling temperature value indicates a sharper probability distribution. Generation probability of the token with relatively low initial probability is decreased, so that the first large language model usually generates a token with relatively high initial probability, quality of the initial question instruction can be improved, but randomness of the initial question instruction can be reduced. Usually, while ensuring quality, a relatively large target sampling temperature value needs to be selected, to improve diversity of initial question instructions generated by the first large language model, so that diversified high-quality seed instruction sets formed by the initial question instructions can be obtained.

In at least one embodiment, before the invoking a first large language model to perform question instruction prediction based on the first prompt text, the temperature parameter of the first large language model is configured as the target sampling temperature value, which is equivalent to that a temperature parameter corresponding to the first large language model when generating the initial question instruction is the target sampling temperature value. It is assumed that a temperature parameter corresponding to the first large language model when generating the first extension question instruction is a first sampling temperature value, and a temperature parameter corresponding to the first large language model when generating the second extension question instruction is a second sampling temperature value, the target sampling temperature value, the first sampling temperature value, and the second sampling temperature value may be the same, may be partially the same, or completely different. This is not limited in this disclosure. Usually, a relatively large first sampling temperature value and a relatively large second sampling temperature value need to be selected, to improve diversity of generation results of the first large language model, thereby obtaining diversified high-quality seed instruction sets.

In a possible implementation, the invoking a first large language model to perform question instruction prediction based on the first prompt text, to generate an initial question instruction may include: invoking the first large language model to perform question instruction prediction based on the first prompt text, to sequentially generate a plurality of initial question instructions, where an instruction similarity between a currently generated initial question instruction and a historically generated initial question instruction is determined each time the initial question instruction is generated, and the currently generated initial question instruction is deleted (or discarded) when the instruction similarity is greater than or equal to a preset similarity threshold.

Implementation manners of invoking the first large language model to perform question instruction prediction based on the first prompt text, to sequentially generate the plurality of initial question instructions include, but are not limited to: manner 1: after inputting the first prompt text into the first large language model, the first large language model can continuously generate new initial question instructions until a stop condition is satisfied, which is equivalent to that a first prompt text is input into the first large language model once, and the first large language model can sequentially generate the plurality of initial question instructions based on the first prompt text, where in this case, the first prompt text may be “Please provide some question instructions related to code generation of JavaScript in front-end development”; and manner 2: the first prompt text is input into the first large language model for a plurality of times, and the first large language model can generate an initial question instruction each time the first prompt text is input into the first large language model, where in this case, the first prompt text may be “Please provide a question instruction related to code generation of JavaScript in front-end development”.

In at least one embodiment, the stop condition may be that a total quantity of the initial question instructions is equal to a preset first threshold, or the stop condition may alternatively be that a related person manually stops a generating process of the first large language model, for example, the related person clicks a stop button or enters a stop instruction on a display interface. A specific form of the stop condition is not limited in this disclosure.

Usually, in the same target task, the first prompt texts input into the first large language model are the same. Because initial question instructions generated by the first large language model are usually obtained by sampling a word list based on a probability distribution, an output of the first large language model may vary. Even if input texts of the first large language model are the same, the first large language model can generate different initial question instructions, and a plurality of different initial question instructions can be obtained.

Based on this, because the output of the first large language model may vary, the initial question instructions generated by the first large language model are usually different, but the first large language model may generate similar initial question instructions. To improve diversity of the initial question instructions, the instruction similarity between the currently generated initial question instruction and the historically generated initial question instruction is determined each time the initial question instruction is generated, to determine, according to a magnitude relationship between the instruction similarity and a similarity threshold, whether to retain or delete the currently generated initial question instruction. When the instruction similarity is less than the similarity threshold, difference between content of the currently generated initial question instruction and content of the historically generated initial question instruction is relatively significant, and the currently generated initial question instruction is retained; on the contrary, when the instruction similarity is greater than or equal to the similarity threshold, difference between the content of the currently generated initial question instruction and the content of the historically generated initial question instruction is relatively small, and the currently generated initial question instruction is deleted. Because the initial question instructions with high content repetition are deleted, diversity of the retained initial question instructions is relatively high, and the seed instruction set with relatively high diversity can be obtained by using a set of the retained initial question instructions as a seed instruction set.

If a quantity of the historically generated initial question instructions is zero, the instruction similarity between the currently generated initial question instruction and the historically generated initial question instruction is zero, but the similarity threshold is usually greater than zero, and the currently generated initial question instruction is retained. If there are a plurality of historically generated initial question instructions, the instruction similarity between the currently generated initial question instruction and each of the historically generated initial question instructions may be separately calculated, then a maximum instruction similarity is selected, and whether to retain or delete the currently generated initial question instruction is determined according to a magnitude relationship between the instruction similarity and the similarity threshold.

The instruction similarity may be determined in a plurality of manners. For example, a cosine similarity between the currently generated initial question instruction and the historically generated initial question instruction may be used as the instruction similarity. For another example, a quantity of common tokens between the currently generated initial question instruction and the historically generated initial question instruction and a total quantity of tokens may be determined, and a ratio of the quantity of common tokens to the total quantity of tokens is used as the instruction similarity. The instruction similarity may alternatively be determined in another manner. This is not limited in this disclosure.

The similarity threshold may be a real number between 0 and 1. When the similarity threshold is larger, a currently generated initial question instruction that is more similar to the historically generated initial question instruction can be retained, which is equivalent to that an initial question instruction whose content slightly differs from that of the historically generated instruction can be retained. Usually, fewer retained initial question instructions have a quality problem, which improves overall quality of the initial question instructions generated by the first large language model, but reduces diversity of the initial question instructions generated by the first large language model. On the contrary, when the similarity threshold is smaller, a currently generated initial question instruction that is less similar to the historically generated initial question instruction can be deleted, which can improve diversity of the initial question instructions generated by the first large language model, but only an initial question instruction whose content greatly differs from that of the historically generated instruction is remained. More retained initial question instructions may have a quality problem, for example, inaccurate syntax or inaccurate content, which reduces overall quality of the initial question instructions generated by the first large language model. Therefore, an appropriate similarity threshold needs to be selected based on existing experience obtained through a plurality of experiments or based on another policy, so that the initial question instructions generated by the first large language model have a balance between diversity and quality, and diversified high-quality seed instruction sets formed by the initial question instructions can be obtained.

A non-limiting example of a process of the sample data generation method is described in detail below.

FIG. 10 is a schematic architecture diagram of a sample data generation method according to an embodiment of this disclosure.

The overall architecture may include an instruction generation module, an instruction complication module, and a multi-round dialog module.

A processing process of the instruction generation module is described in detail below.

First, the instruction generation module acquires a first prompt text.

Then, the instruction generation module acquires a target sampling temperature value and configures a temperature parameter of the first large language model as the target sampling temperature value, the target sampling temperature value being configured for indicating randomness degree of an output result of the first large language model.

Then, the instruction generation module acquires task information of a target task, the target task being a downstream task for training based on sample data.

Then, the instruction generation module determines, in a preset task tree according to the task information, a target node matching the task information, the task tree including a plurality of levels of nodes, each node carrying a respective candidate keyword, and the task tree being pre-constructed.

Then, the instruction generation module uses a node that is associated with the target node and that is located at a target level as a target role definition node, uses a third role definition text carried in the target role definition node as a target role definition text, the target role definition text being configured for prompting the first large language model to act as a questioner for the target task, inputs the target role definition text into the first large language model.

Then, the instruction generation module uses the candidate keyword carried in the target node as a target keyword.

Then, the instruction generation module constructs, when a level at which the target node is located is a target level and according to the target keyword, the first prompt text configured for prompting the first large language model to generate the question instruction according to the task information, the target level being a level subsequent to a level at which a root node in the task tree is located; or
the instruction generation module determines, in the task tree when the level at which the target node is located is the level subsequent to the target level, an associated node associated with the target node, uses the candidate keyword carried in the associated node as an associated keyword, and constructs, according to the associated keyword and the target keyword, the first prompt text configured for prompting the first large language model to generate the question instruction according to the task information, a level at which the associated node is located being previous to the level at which the target node is located.

Then, the instruction generation module invokes the first large language model to perform question instruction prediction based on the first prompt text, to sequentially generate a plurality of initial question instructions. An instruction similarity between a currently generated initial question instruction and a historically generated initial question instruction is determined each time an initial question instruction is generated, and the currently generated initial question instruction is deleted when the instruction similarity is greater than or equal to a preset similarity threshold. The initial question instruction is a single-round question instruction, a set of the initial question instructions may be used as a seed instruction set, and all initial question instructions in the seed instruction set are seed instructions.

Then, the instruction generation module randomly samples a first question instruction from the plurality of initial question instructions.

Then, the instruction generation module constructs, based on a preset extension policy, a third prompt text configured for prompting the first large language model to perform instruction extension according to the extension policy.

Then, the instruction generation module inputs the third prompt text and the first question instruction into the first large language model, and performs a plurality of instruction extensions on the first question instruction, to obtain a first extension question instruction generated by each instruction extension. The instruction extension is performed on the first question instruction according to at least one of the plurality of extension policies each time instruction extension is performed on the first question instruction. A newly generated first extension question instruction is a single-round question instruction. The first extension question instruction may be used as an initial question instruction, and the newly generated initial question instruction is added to a seed instruction set, to perform diversified extension on the seed instruction set.

A processing process of the instruction complication module is described in detail below.

First, the instruction complication module randomly samples a second question instruction from the plurality of initial question instructions.

Then, the instruction complication module constructs a fourth prompt text configured for prompting the first large language model to generate the question instruction with reference to the second question instruction, and inputs the fourth prompt text and the second question instruction into the first large language model to perform question instruction prediction, to generate a second extension question instruction. The newly generated second extension question instruction is a single-round question instruction, and the second extension question instruction may be used as an initial question instruction.

A processing process of a multi-round dialog module is described in detail below.

First, the multi-round dialog module acquires a first role definition text and a second role definition text, the first role definition text being configured for prompting a second large language model to act as an answerer for a target task in a multi-round dialog, the second role definition text being configured for prompting a third large language model to act as a questioner in the multi-round dialog, and the target task being a downstream task for training based on sample data.

Then, the multi-round dialog module inputs the first role definition text into the second large language model, and inputs the second role definition text into the third large language model.

Then, the multi-round dialog module inputs the initial question instruction into the second large language model to perform answer prediction, to generate an answer text of a first dialog round.

Then, the multi-round dialog module constructs a second prompt text configured for prompting the third large language model to generate a question instruction according to the answer text each time the answer text is received.

Then, the multi-round dialog module adds the initial question instruction to the second prompt text, to obtain a fusion prompt text.

Then, the multi-round dialog module inputs the fusion prompt text and the answer text of the first dialog round into the third large language model to perform question instruction prediction, to generate a question instruction of a next dialog round, the fusion prompt text being configured for prompting the third large language model to generate the question instruction according to each question instruction input into the second large language model and the answer text of each dialog round.

Then, the multi-round dialog module inputs the question instruction of the next dialog round into the second large language model to perform answer prediction again, until a round count of the dialog round is equal to a preset round count threshold.

Finally, sample data is constructed based on the question instruction in the multi-round dialog and the answer text in the multi-round dialog.

The sample data may alternatively be constructed by using the single-round question instruction generated by the instruction generation module and the single-round question instruction generated by the instruction complication module. This is not limited in this disclosure.

Based on this, the initial question instruction is generated by using the first large language model, and then a question instruction that is first input into the second large language model is determined according to the initial question instruction, which is equivalent to that the initial question instruction is used as a starting point of the multi-round dialog, and the multi-round dialog is performed by using the second large language model and the third large language model, so that answer texts and question instructions of a plurality of dialog rounds can be obtained, and then sample data is constructed by using the initial question instruction, the question instruction, and the answer text. Because the first large language model can generate high-quality and diversified initial question instructions, the second large language model can generate high-quality and diversified answer texts, and the third large language model can generate high-quality and diversified question instructions. Therefore, complexity and diversity of the question instructions can be improved by combining a plurality of large language models, thereby efficiently obtaining high-quality and diversified sample data.

The sample data generation method according to the embodiments of this disclosure may be applied to a plurality of scenarios.

For example, in a scenario in which a target large language model is applied to an image-text retrieval task, first, task information of the image-text retrieval task is acquired; then, a first prompt text configured for prompting the first large language model to generate a question instruction according to the task information is constructed based on the task information; then, a first prompt text is acquired, a first large language model is invoked to perform question instruction prediction based on the first prompt text, and an initial question instruction is generated; then, a question instruction that is first input into a second large language model is determined according to the initial question instruction, and the second large language model and a third large language model are invoked to perform a multi-round dialog, where the second large language model is configured to generate an answer text according to an input question instruction, and the third large language model is configured to generate, according to the answer text, a question instruction input into the second large language model; and then, sample data is constructed based on a question instruction in the multi-round dialog and an answer text in the multi-round dialog; and then, the target large language model is trained based on the sample data, so that the target large language model can better adapt to the image-text retrieval task.

In at least one embodiment, a training effect of the target large language model is shown in the following Table 1:

TABLE 1

| | Target large | Target large |
|---|---|---|
| | language | language |
| Model | model a | model b |
| Baseline | 24.39 | 23.17 |
| After being trained | 53.66 | 51.83 |
| based on sample data | | |

The sample data is constructed based on the sample data generation method according to at least one embodiment of this disclosure. For example, 100,000 pieces of sample data are constructed, then the target large language model a is trained based on the sample data, and the target large language model b is trained based on the sample data. The target large language model a and the target large language model b both have significant improvement effects.

Although operations in the foregoing flowcharts are sequentially displayed according to instructions of arrows, these operations are not necessarily sequentially performed according to a sequence instructed by the arrows. Unless otherwise explicitly specified in this disclosure, execution of these operations is not strictly limited, and these operations may be performed in another sequence. In addition, at least part operations in the foregoing flowcharts may include a plurality of operations or a plurality of phases, and these operations or phases are not necessarily performed at the same time, but may be performed at different times. These operations or phases are not necessarily sequentially performed, but may be performed in turns or alternately with other operations or at least part of operations or phases in other operations.

FIG. 11 is a schematic structural diagram of a sample data generation apparatus according to an embodiment of this disclosure. The sample data generation apparatus 1100 may include:
a first generation module 1101, configured to acquire a first prompt text, and invoke a first large language model to perform question instruction prediction based on the first prompt text, to generate an initial question instruction;
a second generation module 1102, configured to determine a question instruction of a first-round dialog based on the initial question instruction to perform a multi-round dialog, in each round of dialog, a second large language model being invoked to generate an answer text of a current-round dialog according to a question instruction of the current-round dialog, and in a dialog starting from a second round, a third large language model being invoked to generate a question instruction of a current-round dialog according to an answer text of a previous-round dialog; and
a sample construction module 1103, configured to construct sample data based on a question instruction in the multi-round dialog and an answer text in the multi-round dialog.

Further, a candidate text has at least one knowledge granularity type. The foregoing second generation module 1102 is further configured to: acquire a first role definition text and a second role definition text, the first role definition text being configured for prompting the second large language model to act as an answerer for a target task in the multi-round dialog, the second role definition text being configured for prompting the third large language model to act as a questioner in the multi-round dialog, and the target task being a downstream task for training based on the sample data; and input the first role definition text into the second large language model, and input the second role definition text into the third large language model.

Further, the foregoing second generation module 1102 is configured to: construct a second prompt text configured for prompting the third large language model to generate a question instruction according to the answer text each time the answer text is received; input the second prompt text and the answer text of a first dialog round into the third large language model to perform question instruction prediction, to generate a question instruction of a second-round dialog; and stop the multi-round dialog when a round count of the multi-round dialog is equal to a preset round count threshold.

Further, the foregoing second generation module 1102 is configured to: add the initial question instruction to the second prompt text, to obtain a fusion prompt text; and input the fusion prompt text and the answer text of the first dialog round into the third large language model to perform question instruction prediction, to generate a question instruction of a next dialog round, the fusion prompt text being configured for prompting the third large language model to generate the question instruction according to each question instruction input into the second large language model and the answer text of each dialog round.

Further, the foregoing first generation module 1101 is configured to: acquire task information of a target task, the target task being a downstream task for training based on the sample data; and construct, based on the task information, the first prompt text configured for prompting the first large language model to generate the question instruction according to the task information.

Further, the foregoing first generation module 1101 is configured to: determine, in a preset task tree according to the task information, a target node matching the task information, the task tree including a plurality of levels of nodes, and each node carrying a respective candidate keyword; and use the candidate keyword carried in the target node as a target keyword, and construct, according to the target keyword, the first prompt text configured for prompting the first large language model to generate the question instruction according to the task information.

Further, the first generation module 1101 is configured to: construct, when a level at which the target node is located is a target level and according to the target keyword, the first prompt text configured for prompting the first large language model to generate the question instruction according to the task information; or
determine, in the task tree when the level at which the target node is located is the level subsequent to the target level, an associated node associated with the target node, use the candidate keyword carried in the associated node as an associated keyword, and construct, according to the associated keyword and the target keyword, the first prompt text configured for prompting the first large language model to generate the question instruction according to the task information, a level at which the associated node is located being previous to the level at which the target node is located.

Further, a node located at the target level carries a third role definition text, and the first generation module 1101 is configured to: use a node that is associated with the target node and that is located at the target level as a target role definition node, and use the third role definition text carried in the target role definition node as a target role definition text, the target role definition text being configured for prompting the first large language model to act as a questioner for the target task; and construct, according to the target keyword, a first prompt text configured for prompting the first large language model to generate the question instruction according to the task information, and add the target role definition text to the first prompt text.

Further, there are a plurality of initial question instructions, and the sample data generation apparatus further includes a third generation module (not shown in the figure). The third generation module is configured to: randomly sample a first question instruction from the plurality of initial question instructions; construct, based on a preset extension policy, a third prompt text configured for prompting the first large language model to perform instruction extension according to the extension policy; and input the third prompt text and the first question instruction into the first large language model, perform instruction extension on the first question instruction, to generate the first extension question instruction, and use the first extension question instruction as the initial question instruction.

Further, there are a plurality of extension policies, and the foregoing third generation module is configured to: perform a plurality of instruction extensions on the first question instruction, to obtain a first extension question instruction generated by each instruction extension, where the instruction extension is performed on the first question instruction according to at least one of the plurality of extension policies each time the instruction extension is performed on the first question instruction.

Further, there are a plurality of initial question instructions, and the foregoing first generation module 1101 is further configured to: randomly sample a second question instruction from the plurality of initial question instructions; and construct a fourth prompt text configured for prompting the first large language model to generate the question instruction with reference to the second question instruction, input the fourth prompt text and the second question instruction into the first large language model to perform question instruction prediction, to generate a second extension question instruction, and use the second extension question instruction as the initial question instruction.

Further, the foregoing first generation module 1101 is further configured to: acquire a target sampling temperature value; configure a temperature parameter of the first large language model as a target sampling temperature value, where the target sampling temperature value being configured for indicating randomness degree of an output result of the first large language model.

Further, the first generation module 1101 is configured to: invoke the first large language model to perform question instruction prediction based on the first prompt text, to sequentially generate a plurality of initial question instructions, where an instruction similarity between a currently generated initial question instruction and a historically generated initial question instruction is determined each time the initial question instruction is generated, and the currently generated initial question instruction is deleted when the instruction similarity is greater than or equal to a preset similarity threshold.

The foregoing sample data generation apparatus 1100 is based on the same inventive concept as the sample data generation method applied to a central node. The initial question instruction is generated by using the first large language model, and then a question instruction that is first input into the second large language model is determined according to the initial question instruction, which is equivalent to that the initial question instruction is used as a starting point of the multi-round dialog, the multi-round dialog is performed by using the second large language model and the third large language model, so that answer texts and question instructions of a plurality of dialog rounds can be obtained, and then sample data is constructed by using the initial question instruction, the question instruction, and the answer text. Because the first large language model can generate high-quality and diversified initial question instructions, the second large language model can generate high-quality and diversified answer texts, and the third large language model can generate high-quality and diversified question instructions. Therefore, complexity and diversity of the question instructions can be improved by combining a plurality of large language models, thereby efficiently obtaining high-quality and diversified sample data.

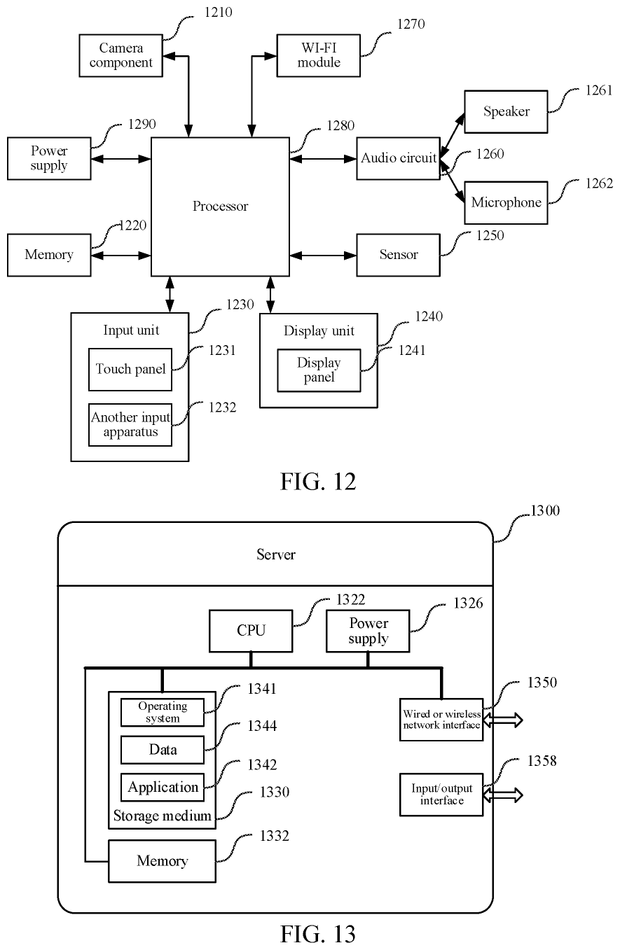

An electronic device that is configured to perform the foregoing sample data generation method according to the embodiments of this disclosure may be a terminal. FIG. 12 is a partial block diagram of a terminal according to an embodiment of this disclosure. The terminal includes components such as a camera component 1210, a memory 1220, an input unit 1230, a display unit 1240, a sensor 1250, an audio circuit 1260, a Wi-Fi module 1270, processing circuitry (e.g., a processor 1280), and a power supply 1290. A person skilled in the art may understand that a structure of the terminal shown in FIG. 12 does not constitute a limitation to the terminal, more components or fewer components than those shown in the figure may be included, or some components may be combined, or a different component deployment may be used.

The camera component 1210 may be configured to collect images or videos. In some embodiments, the camera component 1210 includes a front camera and a rear camera. Usually, the front camera is disposed on a front panel of the terminal, and the rear camera is disposed on a back surface of the terminal. In some embodiments, there are at least two rear cameras, which are respectively any of a main camera, a depth-of-field camera, a wide-angle camera, and a telephoto camera, so as to fuse the main camera and the depth-of-field camera to achieve a background blurring function, fuse the main camera and the wide-angle camera to achieve panoramic photographing and virtual reality (VR) photographing functions or other fusion photographing functions.

The memory 1220 may include a non-transitory computer readable storage medium configured to store a software program and a module. The processor 1280 runs the software program and the module stored in the memory 1220 to execute various functional applications and data processing of the terminal.

The input unit 1230 may be configured to receive input numerical or character information, and generate a key signal input related to terminal setting and function control. In some embodiments, the input unit 1230 may include a touch panel 1231 and another input apparatus 1232.

The display unit 1240 may be configured to display input information or provided information and various menus of the terminal. The display unit 1240 may include a display panel 1241.

The audio circuit 1260, a speaker 1261, and a microphone 1262 may provide audio interfaces.

The power supply 1290 may be alternating current, direct current, a primary battery, or a rechargeable battery.

There may be one or more sensors 1250. The one or more sensors 1250 include, but are not limited to, an acceleration sensor, a gyroscope sensor, a pressure sensor, an optical sensor, or the like.

The acceleration sensor may detect a magnitude of acceleration on three coordinate axes of a coordinate system established with the terminal. For example, the acceleration sensor may be configured to detect components of gravity acceleration on the three coordinate axes. The processor 1280 may control, according to a gravity acceleration signal collected by the acceleration sensor, the display unit 1240 to display a user interface in a landscape view or a portrait view. The acceleration sensor may be further configured to collect motion data of a game or a user.

The gyroscope sensor may detect a body direction and a rotation angle of the terminal. The gyroscope sensor may cooperate with the acceleration sensor to collect a three-dimensional (3D) action of the user on the terminal. The processor 1280 may implement the following functions according to the data collected by the gyroscope sensor: motion sensing (such as changing a user interface (UI) according to a tilt operation of the user), image stabilization at shooting, game control, and inertial navigation.

The pressure sensor may be arranged at a side frame of the terminal and/or a lower layer of the display unit 1240. When the pressure sensor is arranged at the side frame of the terminal, a holding signal of the user on the terminal may be detected. The processor 1280 performs left and right hand recognition or a quick operation according to the holding signal collected by the pressure sensor. When the pressure sensor is arranged on the lower layer of the display unit 1240, the processor 1280 controls, according to a pressure operation of the user on the display unit 1240, an operable control on the UI. The operable control includes at least one of a button control, a scroll-bar control, an icon control, or a menu control.

The optical sensor is configured to collect ambient light intensity. In an embodiment, the processor 1280 may control display brightness of the display unit 1240 according to the ambient light intensity collected by the optical sensor. In some embodiments, when the ambient light intensity is relatively high, the display brightness of the display unit 1240 is increased; and when the ambient light intensity is relatively low, the display brightness of the display unit 1240 is decreased. In another embodiment, the processor 1280 may further dynamically adjust a camera parameter of the camera component 1210 according to the ambient light intensity collected by the optical sensor.

In at least one embodiment, the processor 1280 included in the terminal may perform the sample data generation method according to the foregoing embodiments.

An electronic device configured to perform the foregoing sample data generation method according to one or more embodiments of this disclosure may be a server. FIG. 13 is a partial block diagram of a server according to an embodiment of this disclosure. A server 1300 may vary greatly due to different configurations or performance, and may include processing circuitry (e.g., one or more central processing units (abbreviated as CPUs) 1322 (for example, one or more processors)) and memories (1332), and one or more storage media 1330 (for example, one or more mass storage apparatuses including a non-transitory computer-readable storage medium) for storing applications 1342 or data 1344. The memory 1332 and the storage medium 1330 may be transient or persistent storage. The program stored in the storage medium 1330 may include one or more modules (not shown in the figure), and each module may include a series of instruction operations in the server 1300. Furthermore, the CPU 1322 may be configured to communicate with the storage medium 1330, and perform, on the server 1300, a series of instructions operations in the storage medium 1330.

The server 1300 may further include one or more power supplies 1326, one or more wired or wireless network interfaces 1350, one or more input/output interfaces 1358, and/or one or more operating systems 1341, for example, Windows Server™, Mac OS X™, Unix™, Linux™, or FreeBSD™.

The central processing unit in the server 1300 may be configured to perform the sample data generation method.

An embodiment of this disclosure further provides a non-transitory computer-readable storage medium. The non-transitory computer-readable storage medium is configured to store program code, and the program code is configured to perform the sample data generation method according to the foregoing embodiments.

An embodiment of this disclosure further provides a computer program product. The computer program is stored in a non-transitory computer-readable storage medium. Processing circuitry (e.g., a processor) of an electronic device reads the computer program from the non-transitory computer-readable storage medium, and the processor executes the computer program to enable the electronic device to perform the foregoing sample data generation method.

In the specification and accompanying drawings of this disclosure, the terms “first”, “second”, “third”, “fourth”, and so on (if existent) are intended to distinguish between similar objects but do not necessarily indicate a specific order or sequence. Data used in this way is exchangeable in a proper case, so that the embodiments of this disclosure described herein can be implemented in a sequence different from a sequence shown or described herein. In addition, terms “include” and “have” and any other variants are intended to cover a non-exclusive inclusion. For example, a process, method, system, product, or apparatus that includes a series of operations or units is not necessarily limited to those operations or units that are expressly listed, but may include other operations or units that are not expressly listed or inherent to such a process, method, product, or apparatus.

In this disclosure, “at least one” refers to one or more, and “a plurality of” refers to two or more. Term “and/or” is configured for describing an associative relationship between associated objects and representing that three associations may exist. For example, “A and/or B” may indicate: only A exists, only B exists, and both A and B exist, where A and B may be singular or plural. Character “/” may indicate an “or” relationship between the associated objects. “At least one of the following” or a similar expression thereof refers to any combination of these items, including a single item or any combination of a plurality of items. For example, at least one of a, b, or c may represent a, b, c, “a and b”, “a and c”, “b and c”, or “a, b, and c”, where a, b, and c may be singular or plural.

In the description of this disclosure, “a plurality of (or multiple)” means two or more; “greater than”, “less than”, “exceed”, and the like are understood as excluding a present number; and “above”, “below”, “within”, and the like are understood as including the present number.

In several embodiments provided in this disclosure, the disclosed system, apparatus, and method may be implemented in other manners. For example, the apparatus embodiment described above is only schematic, for example, division of units is only logic function division, and other division manners may be adopted during practical implementation. For example, a plurality of units or components may be combined or integrated into another system, or some features may be neglected or not executed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may or may not be physically separate, and components displayed as units may or may not be physical units, that is, may be located in one place or distributed across over a plurality of network units. Part or all of the units may be selected according to actual needs to achieve purposes of solutions of the embodiments.

In addition, functional units in the embodiments of this disclosure may be integrated into one processing unit, or each unit may exist alone physically, or two or more units may be integrated into one unit. The foregoing integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. In some embodiments, all or part of the technical solutions described this disclosure may be implemented in a form of a software product. The computer software product is stored in a storage medium (e.g., a non-transitory computer-readable storage medium) and includes a plurality of instructions for indicating a computer apparatus (which may be a personal computer, a server, a network apparatus, or the like) to perform all or part operations of the methods described in the embodiments of this disclosure. The foregoing storage medium includes: media that can store program code, such as a universal serial bus flash drive (USB flash drive), a mobile hard disc drive, a read-only memory (abbreviated as ROM), a random access memory (abbreviated as RAM), a magnetic disc, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Implementations provided in one or more embodiments of this disclosure may be combined in various manners to achieve different technical effects.

Technical features of the above embodiments may be combined in different manners to form other embodiments. To make description concise, not all possible combinations of the technical features in the foregoing embodiments are described. However, the combinations of these technical features are considered to be within the scope recorded in this specification provided that no conflict exists.

The foregoing embodiments only describe several implementations of this disclosure, which are not to be construed as a limitation to the scope of this disclosure. For a person of ordinary skill in the art, several transformations and improvements can be made without departing from this disclosure. These transformations and improvements are within the scope of this disclosure.

What is claimed is:

1. A sample data generation method, the method comprising:
generating one or more initial question instructions by a question instruction prediction based on a first prompt text through a first large language model;
determining, by processing circuitry, a question instruction of a first-round dialog of a multi-round dialog based on the one or more initial question instructions;
conducting, by the processing circuitry, the multi-round dialog through a second large language model and a third large language model, the multi-round dialog including:
the first-round dialog that includes generating an answer text of the first-round dialog through the second large language model based on the question instruction of the first-round dialog, and
one or more subsequent-round dialogs, each round of the one or more subsequent-round dialogs including generating a question instruction of a current-round dialog through the third large language model based on an answer text of a previous-round dialog and generating an answer text of the current-round dialog through the second large language model based on the question instruction of the current-round dialog; and
constructing sample data based on the question instructions in the multi-round dialog and the answer texts in the multi-round dialog, the sample data for training a target large language model.

2. The method according to claim 1, further comprising:
configuring the second large language model to act as an answerer for a target task in the multi-round dialog based on a first role definition text; and
configuring the third large language model to act as a questioner in the multi-round dialog based on a second role definition text,
wherein the target task is executable by the target large language model that is trained based on the sample data.

3. The method according to claim 1, wherein the multi-round dialog is stopped when a round count of the multi-round dialog is equal to a preset round count threshold.

4. The method according to claim 1, further comprising:
constructing a second prompt text on which the third large language model is based to generate the question instruction of a second-round dialog of the multi-round dialog; and
generating the question instruction of the second-round dialog through the third large language model based on the second prompt text and the answer text of the first-round dialog.

5. The method according to claim 4, wherein the generating the question instruction of the second-round dialog comprises:
adding the one or more initial question instructions to the second prompt text, to obtain a fusion prompt text; and
inputting the fusion prompt text and the answer text of the first-round dialog into the third large language model, to generate the question instruction of the second-round dialog.

6. The method according to claim 1, further comprising:
acquiring task information of a target task, the target task being executable by the target large language model that is trained based on the sample data; and
constructing, based on the task information, the first prompt text on which the first large language model is based to generate the one or more initial question instructions.

7. The method according to claim 6, wherein the constructing the first prompt text comprises:
determining, in a preset task tree according to the task information, a target node matching the task information, the task tree including a plurality of levels of nodes, each node specifying a respective candidate keyword; and
constructing the first prompt text based on a target keyword that is the candidate keyword specified by the target node.

8. The method according to claim 7, wherein
a level at which the target node is located is a target level that is a level subsequent to a level at which a root node in the task tree is located.

9. The method according to claim 7, further comprising:
determining in the task tree an associated node associated with the target node, when a level at which the target node is located is a level subsequent to a target level, the target level is a level subsequent to a level at which a root node in the task tree is located, and a level at which the associated node is located preceding the level at which the target node is located; and
constructing the first prompt text based on the target keyword and an associated keyword that is the candidate keyword specified by the associated node.

10. The method according to claim 6, wherein
a target level is a level subsequent to a level at which a root node in a task tree is located, and
the method further comprises:
determining a node that is associated with the target node and located at the target level as a target role definition node;
determining a third role definition text specified by the target role definition node as a target role definition text; and
configuring the first large language model to act as a questioner for the target task based on the third role definition text.

11. The method according to claim 1, wherein
the one or more initial question instructions include a plurality of initial question instructions, and
the determining the question instruction of the first-round dialog includes:
randomly sampling a first question instruction from the plurality of initial question instructions;
constructing, based on one or more extension policies, a third prompt text; and
generating a first extension question instruction, as the question instruction of the first-round dialog, through the first large language model based on the third prompt text and the first question instruction.

12. The method according to claim 11, wherein
the one or more extension policies include a plurality of extension policies, and
the generating the first extension question instruction includes performing a plurality of instruction extensions on the first question instruction, to obtain a respective candidate first extension question instruction generated by each instruction extension, each instruction extension being performed on the first question instruction based on at least one of the plurality of extension policies.

13. The method according to claim 1, wherein
the one or more initial question instructions include a plurality of initial question instructions, and
the determining the question instruction of the first-round dialog includes:
randomly sampling a second question instruction from the plurality of initial question instructions;
constructing a fourth prompt text based on the second question instruction; and
generating a second extension question instruction, as the question instruction of the first-round dialog, through the first large language model based on the fourth prompt text and the second question instruction.

14. The method according to claim 1, further comprising:
acquiring a target sampling temperature value; and
configuring a temperature parameter of the first large language model as the target sampling temperature value, the target sampling temperature value indicating a randomness degree of an output result of the first large language model.

15. The method according to claim 1, the method comprising:
invoking the first large language model to perform the question instruction prediction based on the first prompt text, to sequentially generate a plurality of initial question instructions,
wherein, for a currently generated initial question instruction,
an instruction similarity between the currently generated initial question instruction and a historically generated initial question instruction, and
the currently generated initial question instruction is discarded when the instruction similarity is greater than or equal to a preset similarity threshold.

16. A sample data generation apparatus, comprising:
processing circuitry configured to:
generate one or more initial question instructions by a question instruction prediction based on a first prompt text through a first large language model;
determine a question instruction of a first-round dialog of a multi-round dialog based on the one or more initial question instructions;
conduct the multi-round dialog through a second large language model and a third large language model, the multi-round dialog including:
the first-round dialog that includes generation of an answer text of the first-round dialog through the second large language model based on the question instruction of the first-round dialog, and
one or more subsequent-round dialogs, each round of the one or more subsequent-round dialogs including generation of a question instruction of a current-round dialog through the third large language model based on an answer text of a previous-round dialog and generation of an answer text of the current-round dialog through the second large language model based on the question instruction of the current-round dialog; and
construct sample data based on the question instructions in the multi-round dialog and the answer texts in the multi-round dialog, the sample data for training a target large language model.

17. The apparatus according to claim 16, wherein the processing circuitry is configured to:
configure the second large language model to act as an answerer for a target task in the multi-round dialog based on a first role definition text; and
configure the third large language model to act as a questioner in the multi-round dialog based on a second role definition text,
wherein the target task is executable by the target large language model that is trained based on the sample data.

18. The apparatus according to claim 16, wherein the processing circuitry is configured to:
construct a second prompt text on which the third large language model is based to generate the question instruction of a second-round dialog of the multi-round dialog; and
generate the question instruction of the second-round dialog through the third large language model based on the second prompt text and the answer text of the first-round dialog.

19. The apparatus according to claim 16, wherein the processing circuitry is configured to:
acquire task information of a target task, the target task being executable by the target large language model that is trained based on the sample data; and
construct, based on the task information, the first prompt text on which the first large language model is based to generate the one or more initial question instructions.

20. A non-transitory computer-readable storage medium storing instructions, which when executed by a processor, cause the processor to perform a sample data generation method, the method comprising:
generating one or more initial question instructions by a question instruction prediction based on a first prompt text through a first large language model;
determining a question instruction of a first-round dialog of a multi-round dialog based on the one or more initial question instructions;
conducting the multi-round dialog through a second large language model and a third large language model, the multi-round dialog including:
the first-round dialog that includes generating an answer text of the first-round dialog through the second large language model based on the question instruction of the first-round dialog, and
one or more subsequent-round dialogs, each round of the one or more subsequent-round dialogs including generating a question instruction of a current-round dialog through the third large language model based on an answer text of a previous-round dialog and generating an answer text of the current-round dialog through the second large language model based on the question instruction of the current-round dialog; and
constructing sample data based on the question instructions in the multi-round dialog and the answer texts in the multi-round dialog, the sample data for training a target large language model.
